(19) United States
(12) Patent Application Publication
(10) Pub. No.: US 2010/0019487 A1
(43) Pub. Date: Jan. 28, 2010

(54) Coupling with Low Friction Material

(76) Inventors: Charles Peter deCler, Minneapolis, MN (US); Jeremy Nichols, Saint Paul, MN (US)

Correspondence Address: MERCHANT & GOULD PC, P.O. BOX 2903, MINNEAPOLIS, MN, 55402-0903, US

(21) Appl. No.: 12/508,708

(22) Filed: Jul. 24, 2009

Related U.S. Application Data
(60) Provisional application No. 61/083,707, filed on Jul. 25, 2008.

(51) Int. Cl. F16L 37/08; F16L 37/00

(52) U.S. Cl. 285/308; 285/313

(57) ABSTRACT

A female coupling includes a body defining a fluid pathway therethrough, and a slot extending transversely with respect to the fluid pathway, and a latch positioned in the slot to move between locked and unlocked positions. One or both of the body and the latch are molded of a material including a reduced friction additive.

### RELATED APPLICATION

This application claims the benefit of U.S. Patent Application Ser. No. 61/083,707 filed on Jul. 25, 2008, the entirety of which is hereby incorporated by reference.

### BACKGROUND

Quick disconnect couplings are used in various applications to connect two lines to create a fluid pathway therethrough. The couplings typically include cooperating male and female couplings that form the connection. A latch is used to connect the male and female couplings. An example of such a coupling is shown in U.S. Pat. No. 5,104,158 filed on May 31, 1991, the entirety of which is hereby incorporated by reference.

Various components on the couplings can move to accomplish the connection therebetween. For example, a latch of the female coupling (or body) typically moves within the female coupling to connect the female coupling to the male coupling (or insert). Also, the male coupling is typically at least partially received within the female coupling to accomplish the connection.

### SUMMARY

Aspects of the present disclosure relate to systems and methods for forming couplings using materials having reduced frictional properties.

In one aspect, a female coupling includes a body defining a fluid pathway therethrough, and a slot extending transversely with respect to the fluid pathway, and a latch positioned in the slot to move between locked and unlocked positions. One or both of the body and the latch are molded of a material including a reduced friction additive.

### DESCRIPTION OF THE DRAWINGS

The accompanying drawings incorporated in and forming a part of the specification illustrate several aspects of the present disclosure, and together with the description serve to explain the principles of the disclosure.

FIG. 1 is a perspective view of an example coupling including a body and an insert.

FIG. 2 is a perspective view of the body of FIG. 1 with a latch in a locked position.

FIG. 3 is a perspective view of the body of FIG. 2 with the latch in an unlocked position.

FIG. 4 is a perspective view of the insert of FIG. 1.

FIG. 5 is a front perspective view of another body including a locking sleeve.

FIG. 6 is another front perspective view of the body of FIG. 5.

FIG. 7 is a back perspective view of the body of FIG. 5 with the locking sleeve in a first unlocked position.

FIG. 8 is another back perspective view of the body of FIG. 5 with the locking sleeve in a second locked position.

### DETAILED DESCRIPTION

The present application is directed to systems and methods for forming couplings using materials having reduced friction properties.

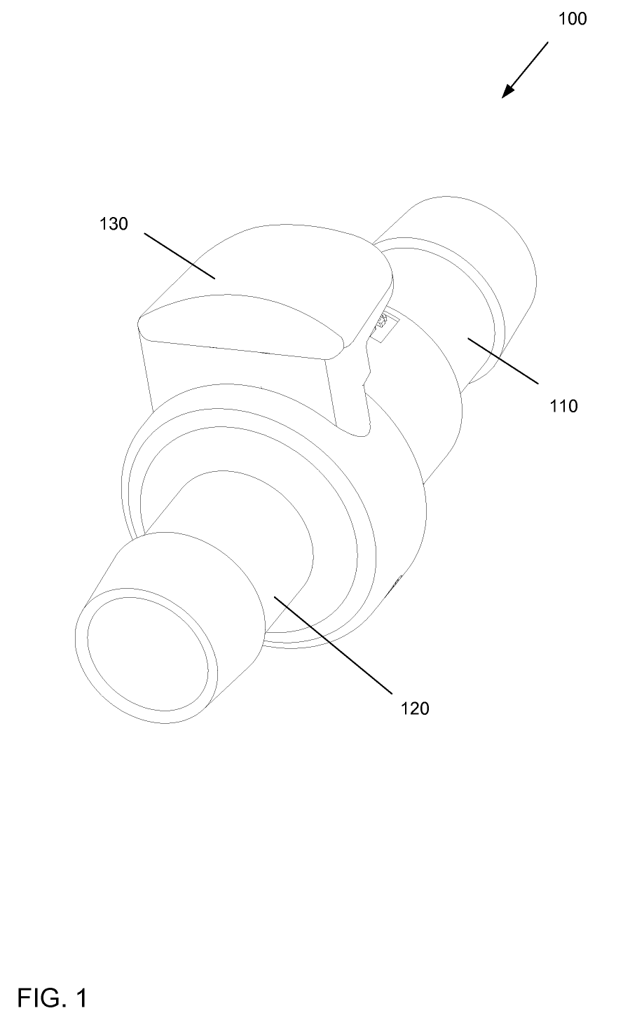

FIG. 1 shows an example coupling 100 including a body 110 (sometimes referred to as a female coupling) and an insert 120 (sometimes referred to as a male coupling).

In the example shown, the insert 120 is partially inserted into and coupled to the body 110 by a clip or latch 130. The body 110 and the insert 120 together form a fluid passage way therethrough. The latch 130 moves in a direction that is generally transverse to the longitudinal direction of the fluid pathway to couple the body 110 and the insert 120, as described further below.

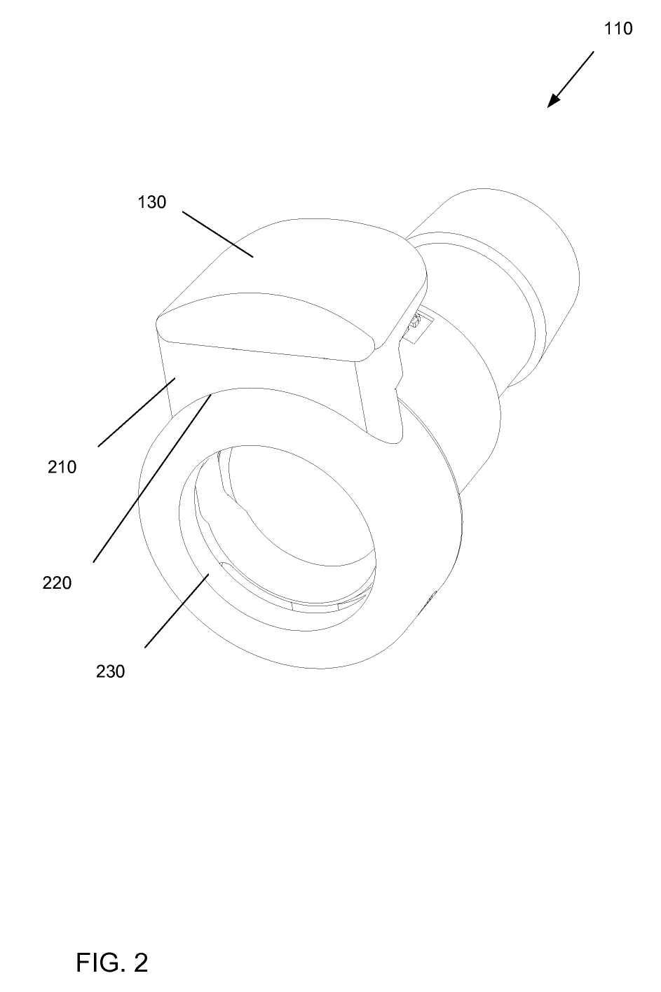

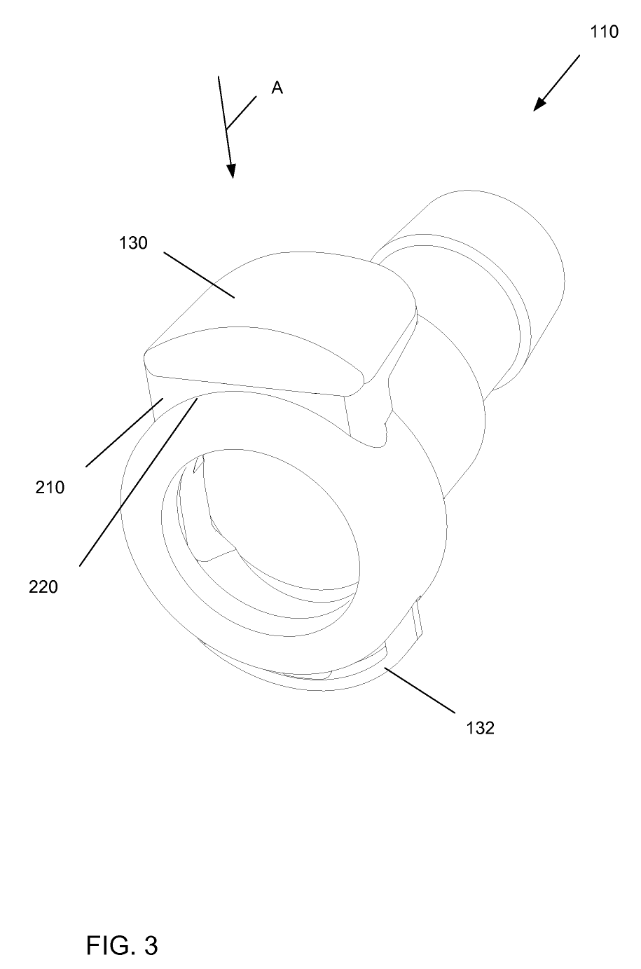

Referring now to FIGS. 2 and 3, the body 110 is shown. The body 110 includes an opening 230 into which the insert 120 is inserted. The latch 130 includes a main body 210 that moves within a slot 220. In FIG. 2, the latch 130 is in a resting or locked position. The latch 130 can be biased or forced into the locked position using a cantilever or spring. In FIG. 3, the latch 130 is moved in a direction A within the slot 220 of the body 110 to an unlocked position. The latch 130 can be moved to this position to, for example, connect or release the portion of the insert 120 that is introduced through the latch 130.

In example embodiments, one or both of the latch 130 and the main body 210 are formed of a reduced friction material (i.e., a material that exhibits a lower coefficient of friction) so that the latch 130 can move freely within the slot 220 from the locked position to the unlocked position. In one example, there can be approximately a 30 percent reduction in the coefficient of friction, although actual performance can vary. In this manner, the likelihood of the latch 130 sticking or otherwise stopping in an intermediate position between the locked and unlocked positions is reduced.

In example embodiments, one or both of the body 110 and the latch 130 are molded of a reduced friction composite material. The composite material includes a base, an additive, and a colorant (optional).

The base can be a polymer such as a Polycarbonate or Polysulfone. The base can also be other polymeric materials such as Polybutylene Terephthalate, Polyethylene Terephthalate, Polyamide, Polyamideimide, Polyimide, Polyoxymethylene, Poly(Acrylonitrile Butadiene Styrene), Polyetherimide, and Polyphenyl Sulfone. Other similar materials can also be used.

The additive can include one or more materials that reduce the frictional characteristics of the base. For example, the additive can be a Perfluoralkylether material or any other miscible fluoropolymer-based additive. In other examples, other materials such as siloxane, silicone oil, aramid fiber, PTFE flakes, or Mica or other mineral or ceramic additives can be used. In the example shown, the additive is a FLUOROGUARD® Polymer Additive manufactured by DUPONT™. Other additives can be used.

In example embodiments, the additive is selected to include one or more of the following characteristics: (i) U.S. Pharmacopoeia (USP) Class VI compliant; (ii) International Organization for Standardization (ISO) 10993 complaint; (iii) animal-free; (iv) does not degrade mechanical properties of base materials (i.e., of the latch); (v) increases yield strength; and (vi) decreases the coefficient of friction by 10 percent, 20 percent, 30 percent, or at least 30 percent. A selected additive need not exhibit all of these characteristics.

The colorant is optional. In example embodiments, the colorant is added to give the component (e.g., the body 110 and/or the latch 130) a desired color. For example, in one embodiment, the colorant is titanium dioxide (TiO₂) to give a white, medical appearance. In other examples, the colorant includes mineral powders or carbon black. Other colorants can be used.

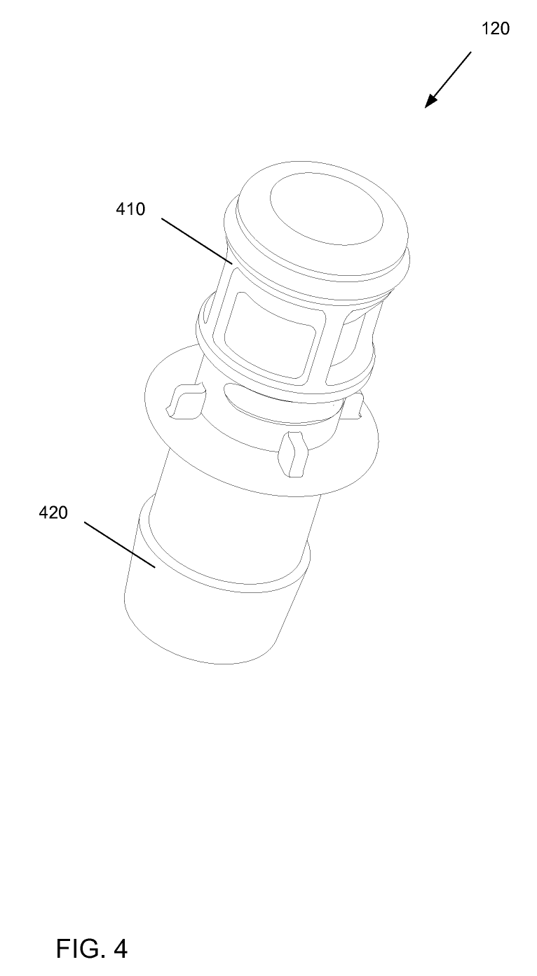

Referring now to FIG. 4, the insert 120 is shown. The insert 120 includes a front portion 410 and a stem portion 420. The front portion 410 can be inserted into the opening 230 in the body 110 and through the latch 130 to couple the insert 120 to the body 110 and to form the fluid pathway therethrough. The stem portion 420 remains outside the body 110 so that a fluid line can be connected thereto. In other examples, the stem portion 420 can be connected directly to a container, such as a flexible bladder.

In example embodiments, the body 110, the insert 120 (including one or both of the front portion 410 and the stem portion 420), and/or the latch 130 are formed of the reduced friction material. In this manner, the front portion 410 of the insert 120 can be inserted into and withdrawn from the opening 230 of the body 110 with a reduced force and without sticking.

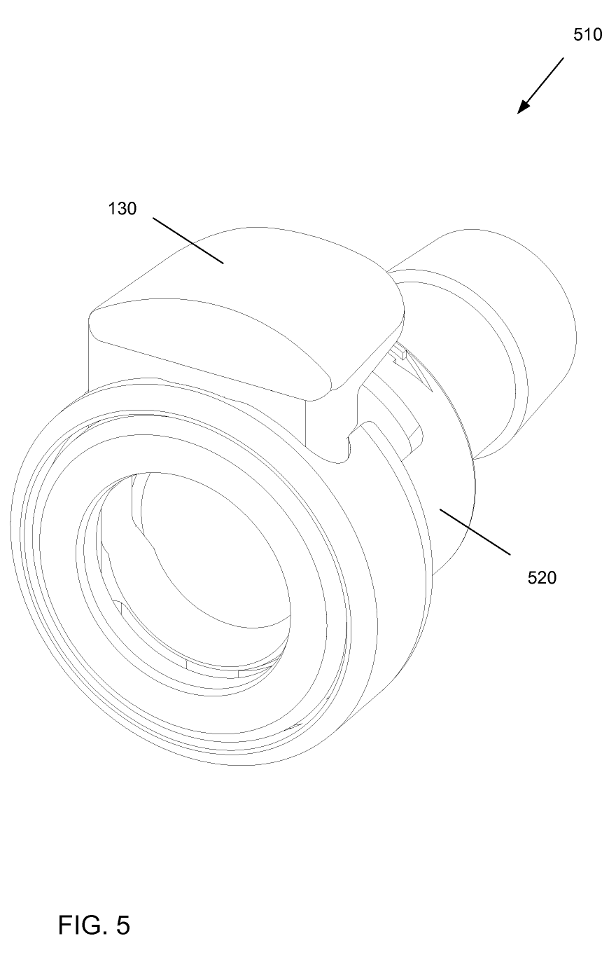

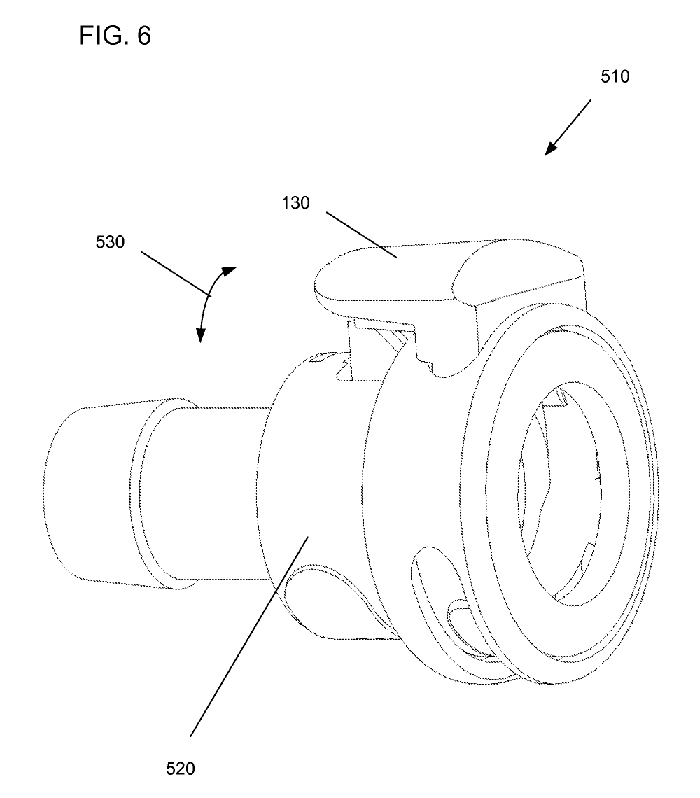

Referring now to FIGS. 5-8, another example body 510 is shown. Body 510 includes the latch 130, as well as a locking sleeve 520. In example embodiments, the locking sleeve 520 rotates about the body 510 in directions 530 between a first position and a second position.

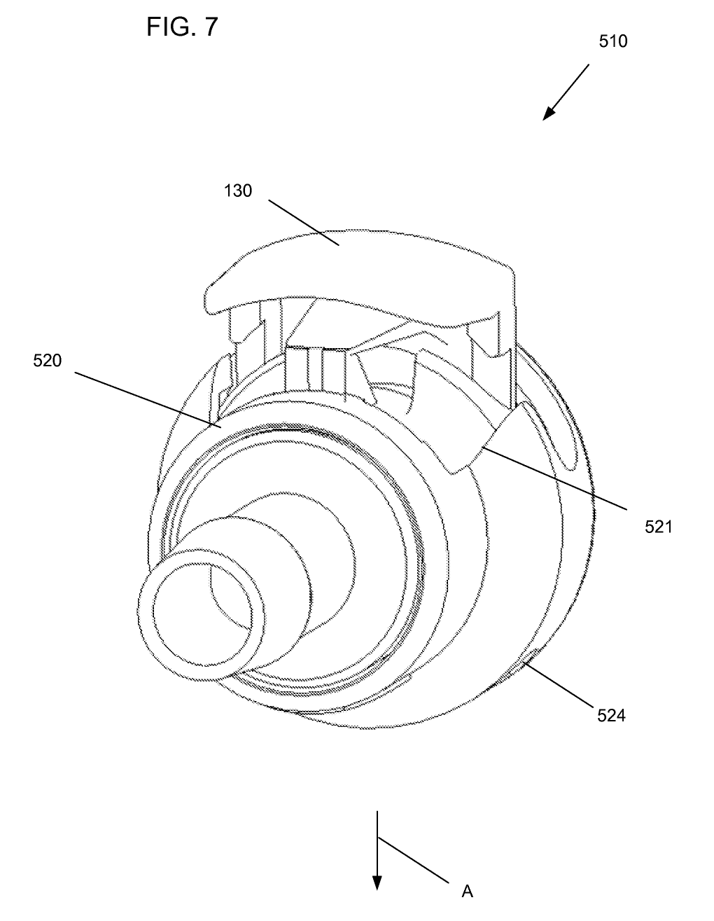

In the first position shown in FIG. 7, the locking sleeve 520 disengages from the latch 130 so that the latch 130 can be moved in the direction A between the locked and unlocked positions, as described above. In this first position, an aperture 521 formed in the locking sleeve 520 allows the latch 130 to move therethrough. In addition, an aperture 524 formed in the locking sleeve 520 allows a lower portion 132 (see FIG. 2) of the latch 130 move therethrough in the direction A to move the latch 130 from the locked to the unlocked position. The locking sleeve 520 can be rotated in the direction 530 to the second position to engage the latch 130.

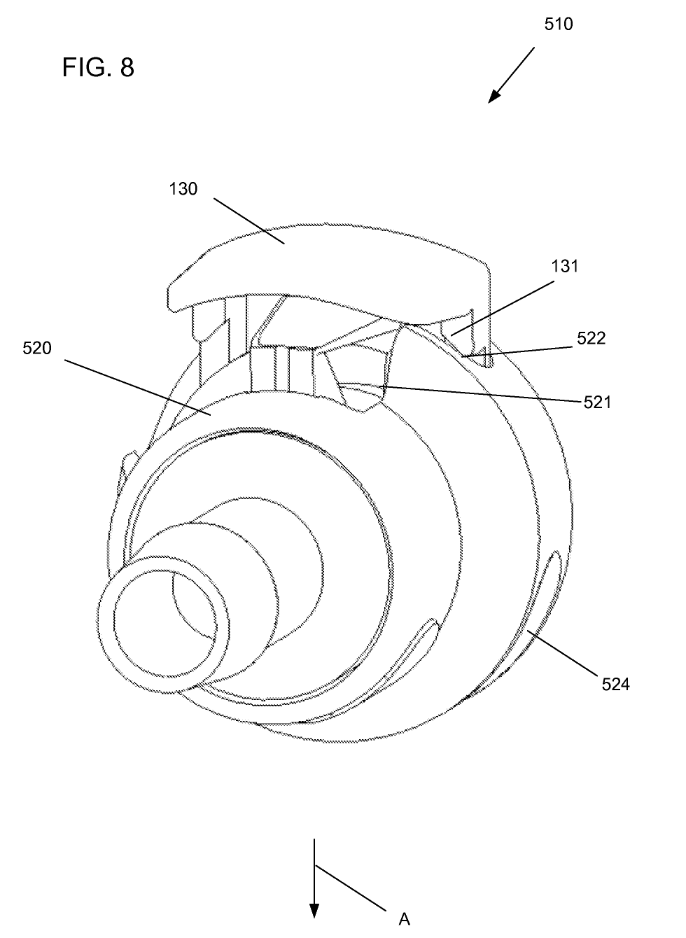

In the second position shown in FIG. 8, the locking sleeve 520 stops the latch 130 from moving to the unlocked position. Specifically, an outer circumference 522 of the locking sleeve 520 is positioned to contact a portion 131 of the latch 130 to prevent the latch from moving in the direction A. Also, the aperture 524 is moved out of alignment with the lower portion 132 of the latch 130 so that the locking sleeve 520 further stops the lower portion 132 of the latch 130 from moving in the direction A. The locking sleeve 520 can be rotated in the opposite direction 530 to move back into the first position to allow the latch 130 to once again be moved.

In example embodiments, the body 510 and/or the locking sleeve 520 can be made of reduced friction material so that the locking sleeve 520 can be rotated about the body 510 without sticking.

In example embodiments, the components described above can be molded as follows. A single, homogenous pelletized resin blend is introduced to a molding machine. In the examples shown, little or no additional lubricants, slip agents, or additives are required. These pellets are introduced into a heated barrel and are stirred, compressed, heated and sheared until melted by a rotating screw that carries the resin forward in the machine. The screw is forced forward by a ram (e.g., hydraulic or electric) to push melted resin out of the far side of the heated barrel, where it is injected into the injection molding tool. In other examples, the low friction material can be added during molding by a metering system, rather than prior to molding in the resin blend. Other configurations are possible.

In example embodiments, the components can be sterilized after molding. Sterilization can include one or more of the following techniques: Gamma sterilization; electron beam sterilization; autoclave; hot steam exposure; dry heat exposure; Ethylene oxide gas exposure; and disinfectants (e.g., Formalin, Isopropyl alcohol, and Ethyl alcohol). In the examples shown, the materials used to make the body, insert, latch, and locking sleeve can be configured to survive one or more of these sterilization techniques.

There are one or more advantages to molding the couplings using the materials and method described herein. For example, the use of a reduced friction additive can reduce or eliminate the need for the use of typical slip agents (e.g., silicone oil) during the molding process. This can also decrease plate-out and die build-up that can be associated with the molding process. The materials can also result in increased melt flow, which can make filling easier during molding and/or allow more cost effective, smaller presses to be used.

Also, as previously noted, the molded components can exhibit reduced friction attributes without requiring use/wear to occur. This can result in decreased marring and scratching of piece parts during molding, as well as during use. For example, there can be a reduction in marring between the latch and the slot in the body in which the latch moves. Other advantages are possible.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. A female coupling, comprising:
a body defining a fluid pathway therethrough, and a slot extending transversely with respect to the fluid pathway; and
a latch positioned in the slot to move between locked and unlocked positions;
wherein one or both of the body and the latch are molded of a material including a reduced friction additive.

2. The coupling of claim 1, wherein the body includes the material with the reduced friction additive.

3. The coupling of claim 2, wherein the latch includes the material with the reduced friction additive.

4. The coupling of claim 3, wherein the material exhibits approximately a 30 percent reduction in a coefficient of friction.

5. The coupling of claim 1, wherein the latch includes the material with the reduced friction additive.

6. The coupling of claim 5, wherein the material exhibits approximately a 30 percent reduction in a coefficient of friction.

7. The coupling of claim 1, further comprising a locking sleeve that rotates between a first position, in which the locking sleeve stops the latch from moving between the locked and unlocked positions, and a second position, in which the locking sleeve allows the latch to move between the locked and unlocked positions.

8. The coupling of claim 7, wherein the locking sleeve includes the material including the reduced friction additive.

9. The coupling of claim 8, wherein the locking sleeve is positioned to rotate about the body of the coupling between the first and second positions.

10. A female coupling, comprising:
a body defining a fluid pathway therethrough, and a slot extending transversely with respect to the fluid pathway;
a latch positioned in the slot to move between locked and unlocked positions; and
a locking sleeve that rotates between a first position, in which the locking sleeve stops the latch from moving between the locked and unlocked positions, and a second position, in which the locking sleeve allows the latch to move between the locked and unlocked positions;
wherein one or more of the body, the latch, and the locking sleeve are molded of a material including a reduced friction additive.

11. The coupling of claim 10, wherein the material exhibits approximately a 30 percent reduction in a coefficient of friction.

12. The coupling of claim 10, wherein the locking sleeve is positioned to rotate about the body of the coupling between the first and second positions.

13. The coupling of claim 10, wherein the locking sleeve is cylindrical.

14. The coupling of claim 13, wherein an outer circumference of the locking sleeve is positioned to contact a portion of the latch to prevent the latch from moving into the unlocked position.

15. The coupling of claim 14, wherein the locking sleeve is rotatable so that the outer circumference rotates away from the latch to allow the latch to move into the unlocked position.

16. A locking sleeve for a female coupling, the locking sleeve comprising:
a main body that defines a first aperture configured to allow a latch of the female coupling to extend therethrough, and a second aperture configured to allow a lower portion of the latch to extend therethrough; and
a portion extending from the main body that is positioned to engage and stop the latch from moving to an unlocked position when the main body is located in a first position with respect to the coupling;
wherein the locking sleeve is molded of a material including a reduced friction additive.

17. The locking sleeve of claim 16, wherein the locking sleeve rotates about the coupling from the first position to a second position in which the latch is moveable to the unlocked position through the first and second apertures of the locking sleeve.

18. The locking sleeve of claim 16, wherein the locking sleeve is cylindrical.

19. The locking sleeve of claim 18, wherein the portion extending from the main body that is positioned to engage and stop the latch is an outer circumference of the locking sleeve.

20. The locking sleeve of claim 19, wherein the locking sleeve is rotatable so that the outer circumference rotates away from the latch to allow the latch to move into the unlocked position.
